(19) United States
(12) Patent Application Publication
(10) Pub. No.: US 2021/0197000 A1
(43) Pub. Date: Jul. 1, 2021

(54) SYSTEM INTEGRATING ASPIRATION SMOKE DETECTOR WITH DELUGE FIRE SUPPRESSION SYSTEM

(71) Applicant: MARIOFF CORPORATION OY, Vantaa (FI)

(72) Inventor: Danylo Kypbida, Gdansk (PL)

(21) Appl. No.: 17/057,367

(22) PCT Filed: Aug. 14, 2019
(86) PCT No.: PCT/EP2019/071879

§ 371 Date: Nov. 20, 2020

(30) Foreign Application Priority Data
Aug. 15, 2018 (EP) 18189119.3

(51) Int. Cl. A62C 37/36; A62C 35/62

(52) U.S. Cl. CPC A62C 37/04; A62C 99/0018; A62C 37/36; A62C 35/62

(57) ABSTRACT

Disclosed is a system for controlling fire in a first area, the system having: a plurality of implements including a source of pressurized fluid and a smoke detector which is an aspirating smoke detector, the fluid source being in a second area and a conduit fluidly connecting the fluid source to the first area, and the smoke detector in a third area, the smoke detector fluidly connected to the conduit for detecting smoke in the first area.

### BACKGROUND

The embodiments herein relate to fire safety systems and more specifically to a system integrating an aspiration smoke detector with a deluge fire suppression system.

An aspirating smoke detector (ASD) system may consist of a central detection unit which draws air through a network of pipes. It may detect smoke before smoke is visible. Deluge fire suppression systems may use open orifice sprinklers, and may be paired with a dedicated fire detection system. Such systems may have common principles: both types of systems may be applied for special hazard areas, both types of systems may use similar channels to transport working medium (that is, pipes), proper maintenance of both types of system may in part focus on an integrity of pipes and unobstructed open orifice sprinklers.

### BRIEF SUMMARY

Disclosed is a system for controlling fire in a first area, the system comprising: a plurality of implements including a source of pressurized fluid and a smoke detector which is an aspirating smoke detector, the fluid source being in a second area and a conduit fluidly connecting the fluid source to the first area, and the smoke detector in a third area, the smoke detector fluidly connected to the conduit for detecting smoke in the first area.

In addition to one or more of the features or elements disclosed in this document or as an alternate the conduit comprises a plurality of fluidly downstream openings in the first area, and the plurality of implements are fluidly upstream of the plurality of openings.

In addition to one or more of the features or elements disclosed in this document or as an alternate the system comprises a first valve controlling stream-wise flow in the conduit from the fluid source.

In addition to one or more of the features or elements disclosed in this document or as an alternate the system comprises a controller for controlling the first valve, the controller opening the first valve when the smoke detector detects smoke in the first area.

In addition to one or more of the features or elements disclosed in this document or as an alternate the system comprises a conduit branch fluidly connecting one of the plurality of implements to the conduit.

In addition to one or more of the features or elements disclosed in this document or as an alternate the system comprises a second valve fluidly controlling stream-wise flow in the conduit to the smoke detector.

In addition to one or more of the features or elements disclosed in this document or as an alternate the controller controls a plurality of valves including the first valve and the second valve, the controller closing the second valve before or after opening the first valve.

In addition to one or more of the features or elements disclosed in this document or as an alternate the plurality of openings in the first area comprise a respective plurality of open orifice sprinklers.

In addition to one or more of the features or elements disclosed in this document or as an alternate the fluid is water and/or a mixture of water and gas.

In addition to one or more of the features or elements disclosed in this document or as an alternate the system comprises a source of negative pressure fluidly connected to the conduit proximate the smoke detector.

Further disclosed is a method of configuring a first suppression system to control a fire in a first area, the method comprising: providing a plurality of implements including a source of pressurized fluid and a smoke detector which is an aspirating smoke detector, disposing the fluid source in a second area and fluidly connecting a conduit between the fluid source and the first area, and disposing the smoke detector in a third area and fluidly connecting the smoke detector with the conduit for detecting smoke in the first area. In addition, the system includes one or more of the features and elements disclosed in this document.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of various components of a fire suppressant system according to a disclosed embodiment; and

FIG. 2 illustrates a process of operating the components illustrated in FIG. 1 according to an embodiment.

### DETAILED DESCRIPTION

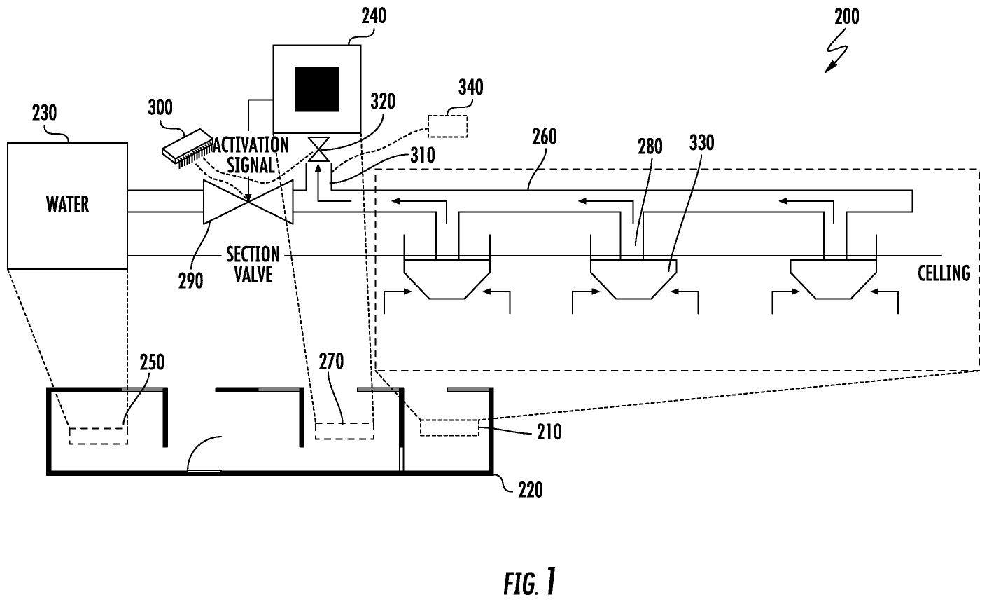

Turning to FIG. 1, disclosed is a system 200 for controlling fire in a first area 210 in a building 220. The building 220 may be one or more of a variety of types of buildings, including but not limited to residential buildings, hotels, office buildings, hospitals, and, generally, any environment where a highly sensitive rapid smoke detection capability is required, including clean rooms, areas which contain goods easily damaged by fire, such as tobacco, electronic rooms, data centers, cable ducts or power stations, historical buildings like theaters, museums and libraries, restrictive areas such as operating rooms, public places such as metro stations, parking garages or prisons, harsh environments like industrial production areas and/or high-ceiling and ventilated areas like warehouses.

The first area 210 may be an apartment, a hotel room, an office, a hospital room and the like. The system 200 may comprise a plurality of implements including a pressurized fluid source 230 and a smoke detector 240 which is an aspirating smoke detector 240, The plurality of implements are used to prevent a fire and/or control the spread of a fire upon detection of smoke.

The fluid source 230 may be in a second area 250 in the building 220, for example a basement or utility area. A conduit 260 fluidly connects the fluid source 230 to the first area 210. The conduit 260 is for example a stainless steel pipe. The smoke detector 240 is in a third area 270 in the building 220. For example the smoke detector 240 may be strategically located in a different room on a same floor and/or different floor in, for example, a distributed system, where such systems may be vertically stacked over a plurality of floors.

According to the disclosed embodiments the smoke detector 240 may be fluidly connected to the conduit 260 for detecting smoke in the first area 210. That is, compared with systems using separate conduits for deluge fire suppressant systems and aspirating fire detection systems, a single conduit 260 is used for both systems herein. This may provide an ease of installation, maintenance and control.

The conduit 260 may comprise a plurality of fluidly downstream openings, including a first opening 280, in the first area 210. For example multiple fluid openings may be provided in the first area 210 for quickly soaking the area 210 to control a fire based emergency. The plurality of implements may be fluidly upstream of the plurality of openings. That is, the fluid source 230 may be fluidly upstream of the first area 210 and may send fluid downstream to the first area 210, and, similarly, the smoke detector 240 may be fluidly upstream of the first area 210.

A first valve 290 may be provided for controlling stream-wise flow in the conduit 260 from the fluid source 230. A controller 300 is provided for controlling the first valve 290. It is to be appreciated that the controller 300 may be part of the smoke detector 240 where the smoke detector 240 has one or more input/output ports that enable controlling one or more valves. The controller 300 may open the first valve 290 when the smoke detector 240 detects smoke in the first area 210. That is, the control of fluid to the first area 210 may be an automated process that initiates upon detecting smoke.

A conduit branch 310 may fluidly connect one of the plurality of implements to the conduit 260. For example the smoke detector 240 may be connected to the conduit 260 through the conduit branch 310. A second valve 320 may fluidly controlling stream-wise flow to the smoke detector 240. The controller 300 may control a plurality of valves including the first valve 290 and the second valve 320.

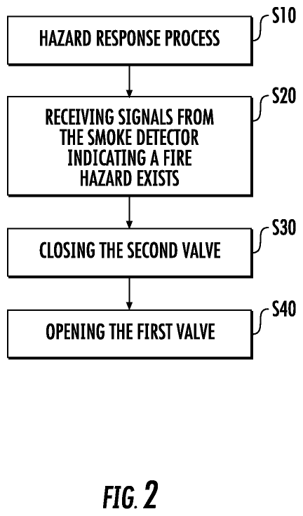

For example, turning to FIG. 2, during a fire emergency, the controller 300 may execute a hazard response process S10. Step S10 may include step S20 of the first controller receiving signals from the smoke detector 240 indicating a fire hazard exists. The controller 300 may then perform step S30 of closing the second valve 320, which may occur sequentially before opening the first valve 290. Then, the second controller 300 may perform a step S40 of opening the first valve 290. That is, by utilizing the second valve 320, the system 200 may fluidly protect the smoke detector 240 from potentially damaging fluid flow from the fluid source 230. In one embodiment steps S30 and S40 might be executed in parallel. In one embodiment step S40 may precede step S30 to minimize response time from smoke detection.

Turning back to FIG. 1, additional features of the system 200, according to one or more embodiments, may include that the plurality of openings in the first area 210 may comprise a respective plurality of open orifice sprinklers, including a first open orifice sprinkler 330.

Additionally, the fluid delivered from the fluid source 230 may be one or more of water and a mixture of water and gas, wherein the gas may be nitrogen or the like, and wherein the gas may enhance atomizing water droplets. Further the system 200 may include a source 340 of negative pressure (illustrated schematically) fluidly connected to the conduit 260 proximate the smoke detector 240. For example the source 340 of negative pressure may be a fan that draws air from the first area 210 to the smoke detector 240. In one embodiment the source 340 of negative pressure is integral with the smoke detector 240. In addition, other known techniques for utilizing aspirating smoke detectors are within the scope of the disclosure. Such techniques may include providing effective smoke detection using conduits spanning long distances, such as but not limited to one hundred meters.

The above disclosed systems may combine piping used by deluge fire suppression systems and aspiration smoke detector systems. Specifically a dual usage for the deluge fire suppression system pipes may be obtained by using these pipes as air channels for the smoke detector.

The above disclosed embodiments may use the same pipe(s) for air sampling as for fire detection and suppression. As a result the above embodiments may provide permanent supervision of water distribution pipe system regarding clogging, dusting, etc. In addition, the above disclosed embodiments may provide an option to implement aspirating smoke detection without retrofitting existing systems, which may be applicable for legacy deluge fire suppression systems as a retrofit option. Further, the disclosed embodiments may provide a reduced labor cost needed to install an aspirating smoke detection system, as well as a reduced space occupied by piping. The disclosed embodiments may provide an extended functionality to existing fire suppression system as well as an improved visual look of a ceiling, due reduced number of openings

As described above, a controller may be utilized with the system. The controller may include processor-implemented processes and devices for practicing disclosed processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A system for controlling fire in a first area, the system comprising:
a plurality of implements including a source of pressurized fluid that is pressurized and a smoke detector which is an aspirating smoke detector,
the fluid source being in a second area and a conduit fluidly connecting the fluid source to the first area, and
the smoke detector being in a third area, the smoke detector fluidly connected to the conduit for detecting smoke in the first area.

2. The system of claim 1 wherein the conduit comprises a plurality of fluidly downstream openings in the first area, and the plurality of implements are fluidly upstream of the plurality of fluidly downstream openings.

3. The system of claim 1 comprising a first valve controlling stream-wise flow in the conduit from the fluid source.

4. The system of claim 3 comprising a controller for controlling the first valve, the controller opening the first valve when the smoke detector detects smoke in the first area.

5. The system of claim 1 comprising a conduit branch fluidly connecting one of the plurality of implements to the conduit.

6. The system of claim 3 comprising a second valve fluidly controlling stream-wise flow in the conduit to the smoke detector.

7. The system of claim 6 wherein the controller controls a plurality of valves including the first valve and the second valve, the controller closing the second valve before or after opening the first valve.

8. The system of claim 2 wherein the plurality of fluidly downstream openings in the first area comprise a respective plurality of open orifice sprinklers.

9. The system of claim 1 wherein the fluid is water and/or a mixture of water and gas.

10. The system of claim 1 comprising a source of negative pressure fluidly connected to the conduit proximate the smoke detector.

11. A method of configuring a first suppression system to control a fire in a first area, the method comprising:
providing a plurality of implements including a source of fluid that is pressurized and a smoke detector which is an aspirating smoke detector,
disposing the fluid source in a second area and fluidly connecting a conduit between the fluid source and the first area, and
disposing the smoke detector in a third area and fluidly connecting the smoke detector fluidly the conduit for detecting smoke in the first area.

12. The method of claim 11 wherein the conduit comprises a plurality of fluidly downstream openings in the first area, and the plurality of implements are fluidly upstream of the plurality of fluidly downstream openings.

13. The method of claim 11 wherein the system comprises a first valve controlling stream-wise flow in the conduit from the fluid source.

14. The method of claim 11 wherein the system comprises a controller for controlling the first valve.

15. The method of claim 11 wherein the system comprises a conduit branch fluidly connecting one of the plurality of implements to the conduit, and a second valve fluidly controlling stream-wise flow to the smoke detector.

16. The method of any of claims 131 15 wherein the system comprises a second valve fluidly controlling stream-wise flow in the conduit to the smoke detector.

17. The method of claims 13 wherein the controller controls a plurality of valves including the first valve and the second valve, the controller closing the second valve before or after opening the first valve.

18. The method of claims 16 wherein the plurality of fluidly downstream openings in the first area comprise a respective plurality of open orifice sprinklers.

19. The method of claim 11 wherein the fluid is water and/or a mixture of water and gas.

20. The method of claim 11 wherein the system comprises a source of negative pressure fluidly connected to the conduit proximate the smoke detector.
